(19) United States
(12) Patent Application Publication
(10) Pub. No.: US 2025/0328867 A1
(43) Pub. Date: Oct. 23, 2025

(54) METHOD, APPARATUS, DEVICE AND STORAGE MEDIUM FOR WORKFLOW AUTOMATION

(71) Applicants: Beijing Zitiao Network Technology Co., Ltd., Beijing (CN); Lemon Inc., Grand Cayman (KY)

(72) Inventors: Sahal KANGO, Los Angeles, CA (US); Bowen SHEN, Beijing (CN); Tianzi YUAN, Los Angeles, CA (US); Junyu WANG, Los Angeles, CA (US)

(21) Appl. No.: 19/053,359

(22) Filed: Feb. 13, 2025

(30) Foreign Application Priority Data
Apr. 23, 2024 (CN) 202410494390.6

(51) Int. Cl. G06Q 10/10

(52) U.S. Cl. CPC G06Q 10/103

(57) ABSTRACT

Embodiments of the disclosure provide a method, an apparatus, a device, and a storage medium for workflow automation. The method includes: in response to an indication of use of a target workflow template among one or more workflow templates, presenting a workflow configuration interface corresponding to the target workflow template; receiving, via the workflow configuration interface, a selection of an information push object and a selection of a work item within a target application; and creating, using the target workflow template and based on the selected information push object and the selected work item, a target workflow for sending a notification associated with the work item to the information push object. In this way, users can create a workflow conveniently and efficiently on one hand, and can use a workflow of an external application in the same platform without manual switching on the other hand. Work efficiency can be improved.

### CROSS-REFERENCE

The present application claims priority to Chinese Patent Application No. 202410494390.6, filed on Apr. 23, 2024 and entitled “METHOD, APPARATUS, DEVICE AND STORAGE MEDIUM FOR WORKFLOW AUTOMATION”, the entirety of which is incorporated herein by reference.

### FIELD

Example embodiments of the present disclosure generally relate to the field of computer, and in particular, to a method, apparatus, a device, and a computer-readable storage medium for workflow automation.

### BACKGROUND

As more and more applications are designed to provide users with various services, users' requirements for using applications are also becoming more diverse. For example, users may use certain capabilities of another application in the process of using a current application. In this case, in the process of using the current application, corresponding capabilities of another application may be provided for users in the form of labels or web pages. However, in the process of switching back and forth between applications, data errors may occur and users' workflow is prone to be interrupted. Therefore, it is expected to break the barriers between the collaborative office platform and other applications, so as to improve the work efficiency of users.

### SUMMARY

In a first aspect of the present disclosure, a method for workflow automation is provided. The method includes: in response to an indication of use of a target workflow template among one or more workflow templates, presenting a workflow configuration interface corresponding to the target workflow template; receiving, via the workflow configuration interface, a selection of an information push object and a selection of a work item within a target application; and creating, using the target workflow template and based on the selected information push object and the selected work item, a target workflow for sending a notification associated with the work item to the information push object.

In a second aspect of the present disclosure, an apparatus for information exchange is provided. The apparatus includes: an interface displaying module configured to, in response to an indication of use of a target workflow template among one or more workflow templates, present a workflow configuration interface corresponding to the target workflow template; a selection receiving module configured to receive, via the workflow configuration interface, a selection of an information push object and a selection of a work item within a target application; and a workflow creating module configured to create, using the target workflow template and based on the selected information push object and the selected work item, a target workflow for sending a notification associated with the work item to the information push object.

In a third aspect of the present disclosure, an electronic device is provided. The device includes at least one processing unit; and at least one memory coupled to the at least one processing unit and storing instructions executable by the at least one processing unit. The instructions, when executed by the at least one processing unit, cause the device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this section is not intended to identify key features or essential features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages, and aspects of various embodiments of the present disclosure will become more apparent when taken in conjunction with the drawings and with reference to the following detailed description. In the drawings, the same or similar reference numerals denote the same or similar elements, where:

FIG. 1 is a schematic diagram of an example environment in which embodiments of the present disclosure can be implemented;

FIGS. 2A-2G are schematic diagrams of example interfaces for authorizing a component running platform to read data of a target application according to some embodiments of the present disclosure;

FIGS. 3A-3C are schematic diagrams of example interfaces for workflow automation according to some embodiments of the present disclosure;

FIGS. 4A-4D are schematic diagrams of example interfaces for presenting a message reminder in a chat window according to some embodiments of the present disclosure;

FIG. 5 is a schematic diagram of an example architecture of a background system for supporting workflow automation according to some embodiments of the present disclosure;

FIG. 6 is a flowchart of a process for workflow automation according to some embodiments of the present disclosure;

FIG. 7 is a schematic block diagram of a structure of an apparatus for workflow automation according to some embodiments of the present disclosure; and

FIG. 8 is a block diagram of an electronic device capable of implementing one or more embodiments of the present disclosure.

### DETAILED DESCRIPTION

It may be understood that before using the technical solutions disclosed in the embodiments of the present disclosure, the user shall be informed of the type, scope of use, use scenarios, etc. of personal information involved in the present disclosure in an appropriate manner in accordance with relevant laws and regulations, and the user's authorization shall be obtained.

For example, in response to receiving an active request from a user, prompt information is sent to the user to explicitly prompt the user that an operation requested by the user will require access to and use of personal information of the user. In this way, the user can independently choose whether to provide personal information to software or hardware such as an electronic device, an application, a server, or a storage medium that performs the operations of the technical solutions of the present disclosure, according to the prompt information.

As an optional but non-limiting implementation, in response to receiving an active request from a user, the prompt information may be sent to the user in the form of a pop-up window, for example, and the prompt information may be presented in text in the pop-up window. In addition, the pop-up window may also include a selection control for the user to select “agree” or “disagree” to provide personal information to the electronic device.

It may be understood that the above process of notifying and acquiring user authorization is only illustrative and does not limit the implementations of the present disclosure, and other manners that meet relevant laws and regulations may also be applied to the implementations of the present disclosure.

It may be understood that the data involved in the technical solutions (including but not limited to the data itself, the acquisition or use of the data) should comply with the requirements of corresponding laws, regulations and related provisions.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of protection of the present disclosure.

It should be noted that the headings of any sections/subsections provided herein are not restrictive. Various embodiments are described throughout this document, and any type of embodiment may be included under any section/subsection. In addition, the embodiments described in any section/subsection may be combined with any other embodiments described in the same section/subsection and/or different section/subsection in any way.

As used herein, unless expressly stated, performing a step “in response to A” does not mean that the step is performed immediately after “A”, but may include one or more intermediate steps.

In the description of the embodiments of the present disclosure, the term “include/include” and its similar terms should be understood as open-ended inclusion, that is, “include/include but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

### Example Environment

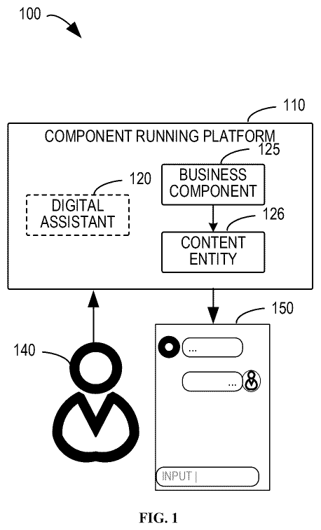

FIG. 1 is a schematic diagram of an example environment 100 in which embodiments of the present disclosure can be implemented. In the example environment 100, a component running platform 110 can support the running of a business component 125. A user 140 can interact with the business component 125 through a client of the component running platform 110.

In some embodiments, the business component 125 may be downloaded and installed in a terminal device of the user 140. In some embodiments, the business component 125 may also be accessed in other ways, such as through a web page. In the environment 100 in FIG. 1, in response to the business component 125 being launched, a client of the component running platform 110 may present an interface 150 of the business component 125.

The business component 125 includes, but is not limited to, one or more of the following: a chat business component (also referred to as an instant messaging business IM component), a document business component, an audio and video conference business component, an email business component, a task business component, a calendar business component, an objective and key result (OKR) business component, and the like. It may be understood that although a single business component is shown in FIG. 1, the component running platform 110 may actually include multiple business components. Multiple business components may be integrated on the component running platform 110, and such a component running platform 110 may be regarded as a multi-functional collaboration platform. In the case that multiple business components are installed in the terminal device, the multiple business components may be integrated on one or more component running platforms 110. In the component running platform 110, people may launch different business components as needed to complete corresponding information processing, sharing, communication, and the like. The business component 125 may provide a content entity 126. The content entity 126 may be a content instance created by the user 140 or other users on the business component 125. For example, depending on the type of the business component 125, the content entity 126 may be a document (e.g., a word document, a pdf document, a presentation, a table document, etc.), an email, a message (e.g., a chat message on the instant messaging business component), a calendar, a schedule, a task, an audio, a video, an image, and the like.

In some embodiments, the component running platform 110 may provide a digital assistant 120. The digital assistant 120 may be provided by a separate business component, or may be integrated in a certain business component 120 capable of providing a content entity. The business component for providing the client interface of the digital assistant may correspond to a single-function business component or a multi-functional collaboration platform, such as an office suite or other collaboration platforms capable of integrating multiple components. It may be understood that, similar to the business component, although a single digital assistant is shown in FIG. 1, there may actually be multiple digital assistants.

In some embodiments, the digital assistant 120 supports the use of plug-ins. Each plug-in can provide one or more functions of the business component. Such plug-ins include, but are not limited to, one or more of the following: a search plug-in, a contact plug-in, a message plug-in, a document plug-in, a table plug-in, an email plug-in, a calendar plug-in, a schedule plug-in, a task plug-in, and the like.

The digital assistant 120 may be an intelligent assistant of the user with intelligent conversation and information processing capabilities. In the embodiments of the present disclosure, the digital assistant 120 is used for interacting with the user 140 to assist the user 140 in using the terminal device or the business component. An interaction window with the digital assistant 120 may be presented in the client interface. In the interaction window, the user 140 can have a conversation with the digital assistant 120 by inputting a natural language, an image, an audio file, a video file, a web page file, etc., to instruct the digital assistant to assist in completing various tasks, including operations on the content entity 126.

In some embodiments, multiple interaction modes between the user 140 and the digital assistant 120 may be provided, and flexible switching between the multiple interaction modes may be achieved. In the case that a certain interaction mode is triggered, a corresponding interaction area is presented to facilitate interaction between the user 140 and the digital assistant 120. The interaction modes between the user 140 and the digital assistant 120 are different in different interaction modes, which may flexibly adapt to interaction requirements in different scenarios.

In some embodiments, an information processing service specific to the user 140 can be provided based on historical interaction information of the user 140 and the digital assistant 120 and/or a data scope specific to the user 140. In some embodiments, historical interaction information of the user 140 interacting with the digital assistant 120 in multiple interaction modes, respectively, may all be stored in association with the user 140. In this way, the digital assistant 120 may provide services for the user 140 based on the historical interaction information stored in association with the user 140 in one of the multiple interaction modes (anyone or a specified interaction mode).

The digital assistant 120 may be invoked or awakened in an appropriate manner (for example, a hotkey, a button, or a voice) to present an interaction window with the user 140. By selecting the digital assistant 120, the interaction window with the digital assistant 120 may be opened. The interaction window may include interface elements for information exchange, such as an input box, a message list, a message bubble, and the like. In some other embodiments, the digital assistant 120 may be evoked through an entry control or a menu provided in a page, or may be evoked by inputting a preset instruction.

The interaction window of the digital assistant 120 and the user 140 may include a chat window, such as a chat window in an instant messaging business component or an instant messaging module of a target business component. In the chat window, interaction between the digital assistant 120 and the user 140 may be presented in the form of chat messages. Alternatively or in addition, the interaction window of the digital assistant 120 and the user 140 may also include other types of windows, such as a window in a floating window mode, where the user 140 may trigger the digital assistant 120 to perform a corresponding operation by inputting an instruction, selecting a quick instruction, or the like.

In some embodiments, the digital assistant 120 may support an interaction mode of the chat window, which is also referred to as a chat mode. In this interaction mode, a chat window of the user 140 and the digital assistant 120 is presented, and the user 140 and the digital assistant 120 interact through chat messages in the chat window. In the chat mode, the digital assistant 120 may perform a task according to the chat messages in the chat window. In the interaction window, the user 140 inputs an interaction message, and the digital assistant 120 provides a reply message in response to the user input.

In some embodiments, the chat mode of the user 140 and the digital assistant 120 may be invoked or awakened in an appropriate manner (for example, a hot key, a button, or a voice) to present a chat window. By selecting the digital assistant 120, the chat window with the digital assistant 120 may be opened. The chat window may include interface elements for information exchange, such as an input box, a message list, a message bubble, and the like.

In some embodiments, the digital assistant 120 may support an interaction mode of a floating window (or floating window), also known as a floating window mode. In the case that the floating window mode is triggered, an operation panel (also known as a floating window) corresponding to the digital assistant 120 is presented, and the user 140 may issue an instruction to the digital assistant 120 based on the operation panel. In some embodiments, the operation panel may include at least one candidate quick instruction. Alternatively or in addition, the operation panel may include an input control for receiving instructions. In the floating window mode, the digital assistant 120 may perform a task according to instructions issued by the user 140 through the operation panel.

In some embodiments, the floating window mode of the user 140 and the digital assistant 120 may also be invoked or awakened in an appropriate manner (for example, a hotkey, a button, or a voice) to present a corresponding operation panel. In some embodiments, the digital assistant 120 may be supported to be awakened in a specific business component, for example, in a document business component, so as to provide interaction in the floating window mode. In some embodiments, to trigger the floating window mode to present the operation panel corresponding to the digital assistant 120, an entry control for the digital assistant 120 may be presented in the interface of the business component. In response to detecting a trigger operation for the entry control, it may be determined that the floating window mode is triggered, and the operation panel corresponding to the digital assistant 120 is presented in the target interface area.

In some embodiments described below, for purpose of discussion, the interaction window of the user and the digital assistant is mainly illustrated as a chat window for example.

The component running platform 110 may be deployed locally in a terminal device of each user 140, and/or may be supported by a server-side device. For example, the terminal device of the user 140 may run a client of the component running platform 110, and the client may support interaction of the user 140 with the component running platform 110 provided by the server side. In the case that the component running platform 110 runs locally on the terminal device of the user, the user 145 may directly interact with the local component running platform 110 using the terminal device. In the case that the component running platform 110 runs on a server-side device, the server-side device may implement service provision to the client running in the terminal device based on a communication connection with the terminal device. The component running platform 110 may present a corresponding interface 150 to the user 140 based on an operation of the user 140, so as to output information related to the use of the component to the user 140 and/or receive information related to the use of the component from the user 140.

The component running platform 110 may run on an appropriate electronic device. The electronic device here may be any type of device with computing power, including a terminal device or a server-side device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices, or any combination thereof. The server-side device may include, for example, a computing system/server, such as a mainframe, an edge computing node, a computing device in a cloud environment, and the like. In some embodiments, the component running platform 110 may be implemented based on cloud services.

It should be understood that the structure and function of each element in the environment 100 are only described for example purposes, without implying any limitation to the scope of the present disclosure.

At present, users can open an external application (for example, a third-party application) via a tab page/web page within a component running platform, but cannot break the workflow of the external application and the suite included in the component running platform. In some work scenarios, the component running platform provides an alternative suite capability, but users have a high data migration cost.

Furthermore, if the user needs to switch frequently between the component running platform and the external application, various data errors, such as data, organization, and authority, are prone to occur, and the user's workflow is prone to be interrupted and cannot be focused. Correspondingly, problems such as data asynchronization will have a certain impact on the user's retention rate.

In view of this, the embodiments of the present disclosure propose an improved solution for workflow automation. According to various embodiments of the present disclosure, a workflow configuration interface corresponding to a target workflow template among one or more workflow templates is presented in response to an indication of use of the target workflow template. The one or more workflow templates are used for a target application. Then, the component running platform receives, via the workflow configuration interface, a selection of an information push object and a selection of a work item within the target application. Further, the component running platform creates, using the target workflow template, a target workflow based on the selected information push object and the selected work item. The target workflow is used to send, to the selected information push object, a notification of an action associated with the selected work item.

In the embodiments of the present disclosure, a workflow template for a target application (for example, an external application) is provided for the user. The user only needs to select an appropriate template and set a corresponding source and destination, without manually building various nodes of the workflow. In this way, the user can create a workflow conveniently and efficiently on one hand, and can use a workflow of an external application in the same platform without manual switching on the other hand. In this way, work efficiency can be improved.

Some example embodiments of the present disclosure will be described below with continued reference to the drawings. It should be understood that the interfaces shown in the drawings are only examples, and various interface designs may actually exist. Various graphic elements in the interface may have different arrangements and different visual representations, one or more of the elements may be omitted or replaced, and one or more other elements may exist. The embodiments of the present disclosure are not limited in this regard. In addition, the example embodiments will be mainly described below with respect to the component running platform 110. It should be understood that the actions described with respect to the component running platform 110 may be performed by an application, a component, or a suite (for example, the business component 125) on the component running platform 110, or may be performed by an application, a component, or a suite in conjunction with its server side (for example, a server).

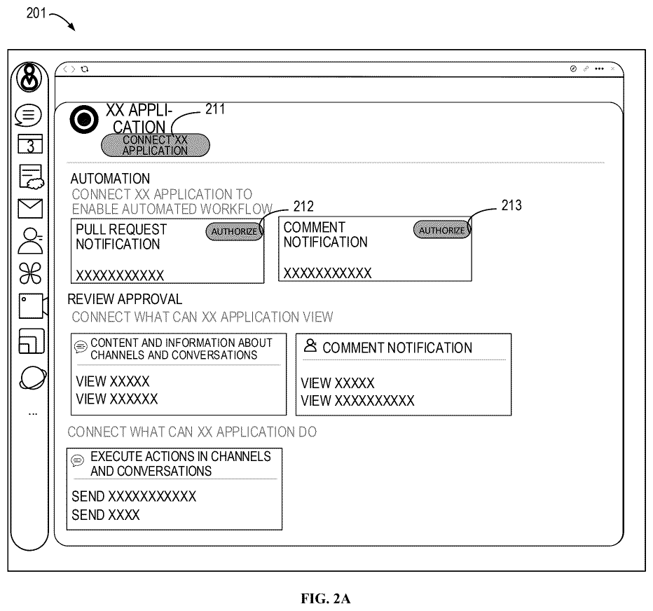

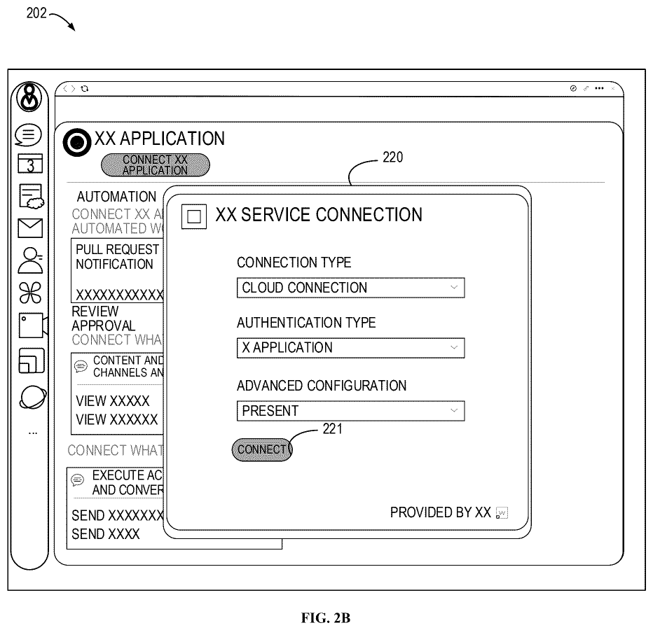

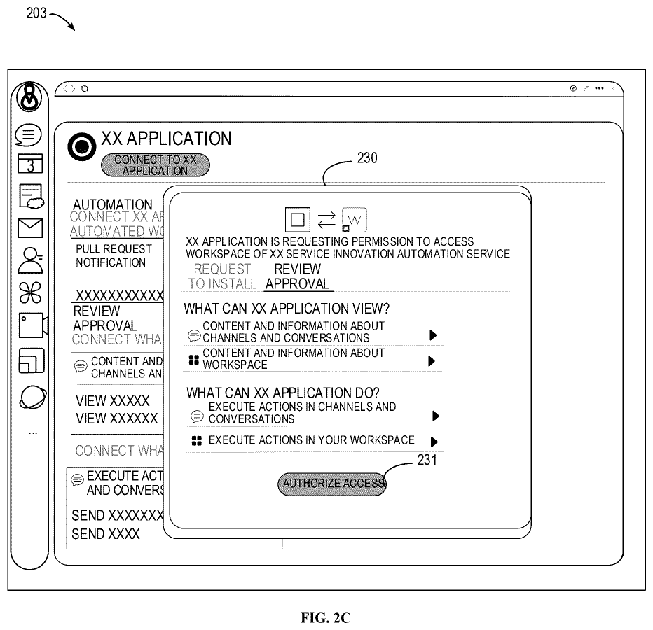

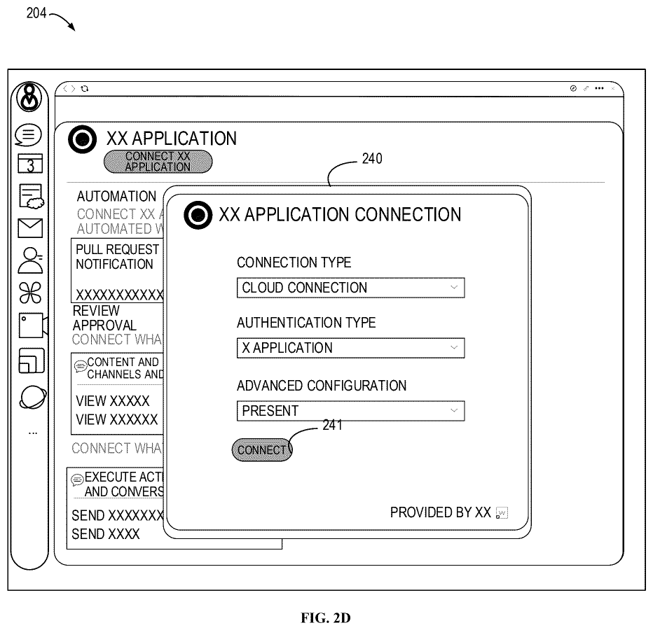

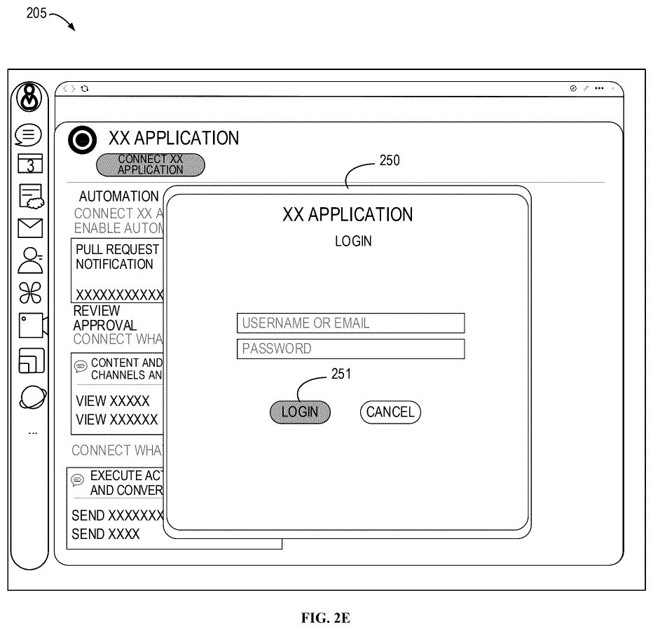

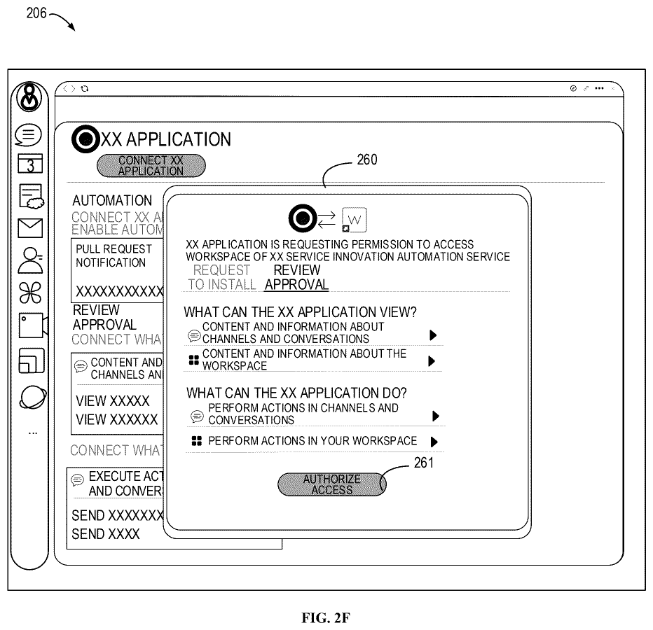

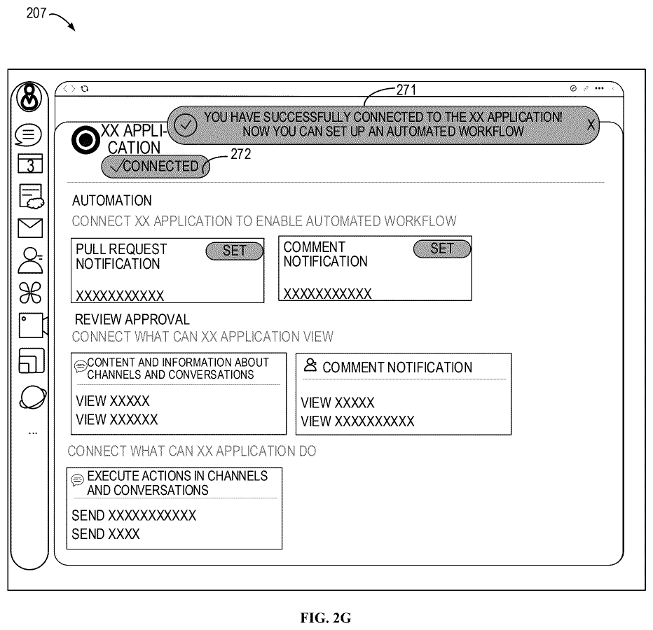

For ease of understanding, the following first describes, with reference to FIGS. 2A-2G, the user's authorization of the component running platform 110 to read data of a target application (for example, a “third-party application” or an “external application”) to enable the component running platform 110 to monitor the dynamics of the target application in real time and provide update reminders in the chat window. FIGS. 2A-2G are schematic diagrams of example interfaces 201-207 for authorizing a component running platform to read data of a target application according to some embodiments of the present disclosure. For purpose of discussion, the following will be described with reference to FIG. 1.

In some embodiments, the component running platform 110 receives, via an interface associated with the target application, a user indication to initiate workflow automation for the target application. The component running platform 110 receives a user indication from an interface associated with the target application presented by the component running platform 110, and the user indication is an indication to initiate workflow automation for the target application. In some examples, the target application may be an external application, such as a code development application. In the embodiments of the present disclosure, an external application or a third-party application refers to an application provided at least in part by other parties than the component running platform 110. Some embodiments will be described below with respect to a code development application, but it should be understood that this is only for example, without suggesting any limitations. The embodiments of the present disclosure may be applied to any suitable type of application.

As shown in FIG. 2A, an example interface 201 is an interface associated with a target application (e.g., an XX application). On this interface, a control 211 corresponding to “Connect XX application”, a setting control 212 corresponding to a workflow template “Pull request notification” and a setting control 213 corresponding to a workflow template “Comment notification” are presented. The user can trigger any one of the control 211, the setting control 212, or the setting control 213 to initiate a workflow automation service for the target application. Accordingly, the component running platform 110 receives the user indication of the user on the interface associated with the target application.

In some embodiments, the component running platform 110 obtains the authorization information associated with the automation service in response to the user indication. If the component running platform 110 receives the user indication from the user 140, it obtains the authorization information associated with the automation service (sometimes also referred to as “service party”). In some examples, the automation service may be provided by a related party other than the component running platform 110.

In some embodiments, the authorization information associated with the automation service obtained by the component running platform 110 includes first authorization information of an information push service to the automation service. The component running platform 110 implements authorization between the information push service and the automation service based on the user's authorization. It may be understood that the information push service may be a service provided by the component running platform 110, such as an instant messaging (IM) service provided by the component running platform 110. It should be understood that the actions described with respect to the component running platform 110 may be performed by the component running platform 110 that provides the information push service.

The authorization information associated with the automation service obtained by the component running platform 110 further includes second authorization information of the target application to the automation service. In some examples, the component running platform 110 implements authorization between the target application and the automation service based on the user's authorization.

Subsequently, the component running platform 110 starts a use control for the one or more workflow templates in response to obtaining the authorization information. If the component running platform 110 obtains, from the user, authorization information authorizing the component running platform 110 to read the data of the target application, it starts the use control for the one or more workflow templates.

In some examples, the user's authorization of the component running platform 110 to read the data of the target application may be divided into two cases: first authorization and non-first authorization. In some examples, since the component running platform 110 adopts a unified background provided by the automation service (sometimes also referred to as “service party”), for the first authorization, the component running platform 110 needs to be authorized to the automation service first, and then the target application is authorized to the automation service. In particular, since the authorization between the component running platform 110 and the automation service is a one-time authorization, there is no need to repeat the operation. Therefore, for the non-first authorization, only the authorization information between the target application and the automation service needs to be obtained.

The following describes, with reference to example interfaces 202-203 shown in FIGS. 2B-2C, the component running platform 110's obtaining of first authorization information of an information push service (for example, an XX service) to the automation service. The component running platform 110 presents a window 220 for obtaining the authorization information in response to the user indication. The component running platform 110 displays, on the window 220, a connection type, an authentication type, an advanced configuration, etc., for the user to select a connection type, an authentication type, an advanced configuration, etc. corresponding to the “XX service”.

The component running platform 110 presents a window 230 for obtaining the authorization information in response to the user clicking a “Connect” control 221. The component running platform 110 displays on the window 230 “What can the XX application view”, “What can the XX application do”, etc., for the user to set the functions that can be used by the XX application. The component running platform 110 obtains the first authorization information of the information push service to the automation service in response to the user clicking an “Authorize access” control 231 on the window 230.

The component running platform 110's obtaining of second authorization information of the target application (for example, an XX application) to the automation service will be continued to be described below with reference to example interfaces 204-206 shown in FIGS. 2D-2F. The component running platform 110 presents a window 240 for obtaining the second authorization information while obtaining the first authorization information in response to the user clicking the “Authorize access” control 231 on the window 230. The component running platform 110 displays on the window 240 a connection type, an authentication type, an advanced configuration, etc., for the user to select a connection type, an authentication type, an advanced configuration, etc. corresponding to the “XX application”.

The component running platform 110 presents a login window 250 for logging in to the “XX application” in response to the user clicking a “Connect” control 241 on the window 240. After receiving the information input by the user, the component running platform 110 presents a window 260 for obtaining the second authorization information in response to the user clicking a “Login” control 251.

The component running platform 110 displays on the window 260 “What can the XX application view”, “What can the XX application do”, etc., for the user to set the functions that can be used by the XX application. The component running platform 110 obtains the second authorization information of the target application to the automation service in response to the user clicking an “Authorize access” control 261 on the window 260.

Then, after the component running platform 110 obtains the authorization information, it enables a use control for the one or more workflow templates. As shown in an example interface 207 in FIG. 2G, the component running platform 110 presents the interface 207 after obtaining the second authorization information of the target application to the automation service in response to the user clicking the “Authorize access” control 261 on the window 260, where the interface 207 includes a use control for enabling the one or more workflow templates.

In the interface 207, the component running platform 110 presents prompt information 271 “You have successfully connected to the XX application, and now you can set up an automated workflow” to prompt the user that the connection is successful and that the use control for the one or more workflow templates can be enabled. The component running platform 110 also presents the control 211 of “Connect XX application” presented when not connected or during the connection process as a “Connected” control 272 in the interface 207.

In this way, by authorizing the component running platform 110 to read the data of the target application, the component running platform 110 can monitor the dynamics of the target application in real time and provide update reminders in the chat window.

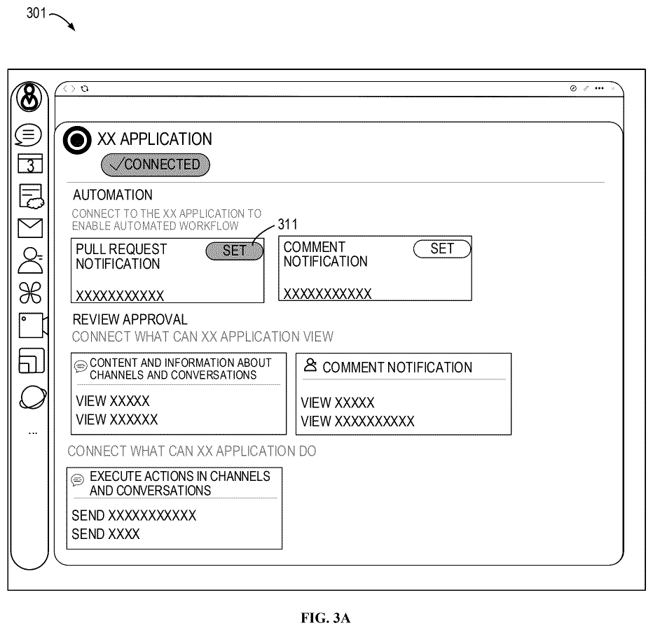

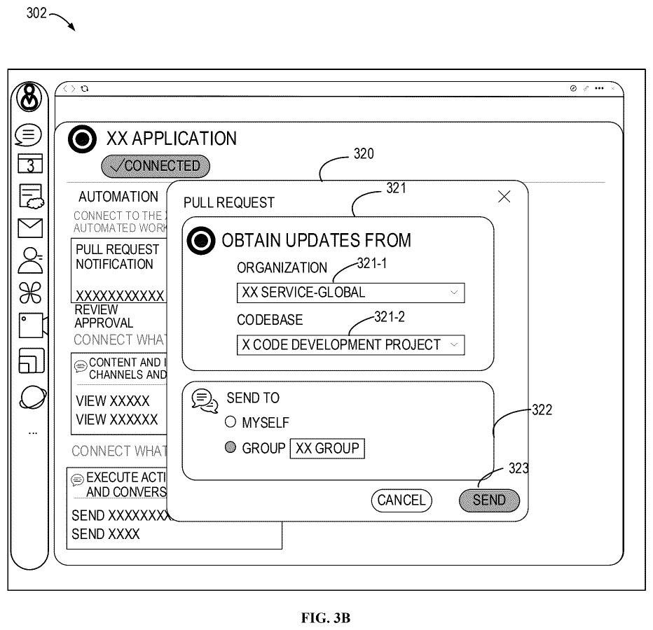

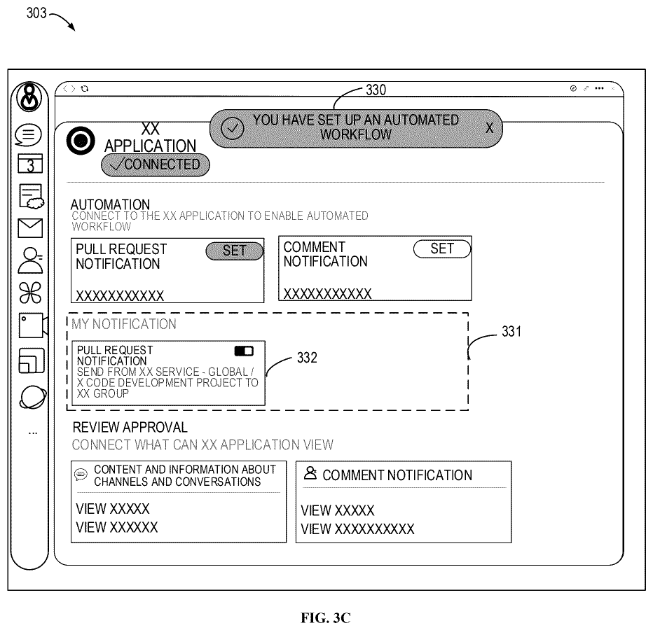

The solution of the present disclosure for workflow automation after authorizing the component running platform 110 to read the data of the target application will be described below with reference to FIGS. 3A-3C. FIGS. 3A-3C are schematic diagrams of example interfaces 301-303 for workflow automation according to some embodiments of the present disclosure. For the purpose of discussion, the following will be described with reference to FIG. 1 and FIG. 2G.

In some embodiments, the component running platform 110 presents a workflow configuration interface corresponding to a target workflow template among the one or more workflow templates in response to an indication of use of the target workflow template. In some embodiments, the one or more workflow templates are used for a target application, as shown in FIGS. 2A-2G. In other embodiments, the workflow template may be generic or shared by multiple applications when created. In this case, the user may select a workflow template to be used for the target application.

In some embodiments, the workflow nodes in the workflow template are pre-configured. That is, the user does not need to set up the workflow nodes and the associations between different nodes. In some examples, the workflow nodes may be provided by the automation service. For example, the automation service may analyze the characteristics of work items in the application and extract and summarize the workflow nodes. Further, the component running platform 110 may pre-configure the workflow nodes according to information provided by the automation service. In this case, the workflow nodes may be imperceptible to the user.

In some embodiments, the workflow template may include at least one of: one or more configurable parameters for the information push object, or one or more configurable parameters for the work item in an application. That is, the user may configure the information push object as the destination of the workflow. The user may configure the work item as the source of the workflow. Such configurable parameters are described below with reference to FIGS. 3A-3C.

In some embodiments, the one or more workflow templates provided may be used for different types of work items. For example, the “Pull request notification” workflow template and the “Comment notification” workflow template in the example of FIG. 2A are used for different types of work items, specifically, a code pull type work item and a code comment type work item.

In some examples, if the component running platform 110 detects an indication of use of a target workflow template among the one or more workflow templates from the user, it will present a workflow configuration interface corresponding to the target workflow template. For example, the workflow template may be a “Pull request notification” workflow template, a “Comment notification” workflow template, and so on.

In some examples, after receiving the authorization information, the component running platform 110 presents an interface including a use control of the target workflow template. The component running platform presents the workflow configuration interface corresponding to the target workflow template in response to the user clicking the use control in the interface.

As shown in example interfaces 301-302 in FIGS. 3A-3B, after receiving the authorization information, the component running platform 110 presents an interface 301 including a “Set” control 311 of the “Pull request notification” workflow template. The component running platform 110 presents a workflow configuration interface 302 corresponding to the “Pull request notification” workflow template in response to a trigger operation of the “Set” control 311 presented by the user on the interface 301.

In some embodiments, the component running platform 110 receives, through the workflow configuration interface, a selection of an information push object and a selection of a work item within the target application. In some examples, the user selects the information push object on the workflow configuration interface provided by the component running platform 110. Correspondingly, the user selects a work item, for example, a certain code development project, on the workflow configuration interface provided by the component running platform 110. Then, the component running platform 110 receives the user's selection on the workflow configuration interface.

As shown in the example interface 302 in FIG. 3B, the user selects the information push object in an area 322 presented on a window 320 in the workflow configuration interface 302 provided by the component running platform 110. Correspondingly, the user selects the work item in an area 321 presented on the window 320 in the workflow configuration interface 302 provided by the component running platform 110.

In some examples, the information push object may include an individual user, for example, the current user himself/herself. The information push object may also include multiple users belonging to the same chat, for example, a certain group of instant messaging (IM). The information push object may also include multiple users, which may not belong to an established group.

In some embodiments, the component running platform 110 may display a first selection entry and a second selection entry. The component running platform 110 may receive, through the first selection entry, a selection of a tenant among one or more authorized tenants in the target application. Then, the component running platform 110 may receive, through the second selection entry, a selection of a work item among one or more work items under the selected tenant. As used herein, a tenant refers to an independent entity that uses a service or a resource, and a tenant may have its own users, permission, data, configuration, etc.

In some examples, the component running platform 110 receives a certain organization, or a certain team, etc. in the target application (for example, “XX application”) selected by the user in the first selection entry. Then, the component running platform 110 continues to receive a work item among one or more work items under a certain organization or a certain team selected by the user in the second selection entry. For example, the component running platform receives a certain code development project under a certain organization selected by the user.

Continuing to refer to the example interface 302 shown in FIG. 3B, the component running platform 110 receives a certain organization in a target application (for example, “XX application”) selected by the user in the first selection entry 321-1. After that, the component running platform 110 receives an “X code development project” in the codebase under a certain organization selected by the user in the second selection entry 321-2.

In some embodiments, the component running platform 110 creates a target workflow using the target workflow template based on the information push object selected by the user and the work item selected by the user. If the user has completed the selection of the information push object and the work item, the component running platform will create the target workflow using the target workflow template. For example, the component running platform 110 creates a target workflow using the “Pull request notification” workflow template selected by the user according to the information push object and the work item selected by the user.

As shown in example interfaces 302-303 in FIGS. 3B-3C, the user completes the selection of the information push object and the work item, and clicks a “Send” control 323. The component running platform 110 presents a full interface 303 based on the information push object and the work item in response to the user's trigger operation on the control 323.

The component running platform 110 presents a newly created target workflow 332 in an area 331 included in the interface 303. The component running platform 110 also displays the source and destination of the target workflow 332. Continuing with the above example, the user selects the “X code development project” in the codebase under a certain organization and selects to send it to the “X group”. Subsequently, the component running platform 110 presents the source and destination of the target workflow 332 in response to the user's selection: “Send from a certain organization/X code development project to the X group”. Correspondingly, the component running platform 110 also displays prompt information 330 “You have set up an automated workflow” on the interface 303.

In some examples, the component running platform 110 may inform the user which tenants are included in the user's account based on the first selection entry 321-1, and inform the user which codebases (sometimes also referred to as “repositories”) may be selected to be added to the workflow based on the second selection entry 321-2. Therefore, the user can use the entire service without leaving the component running platform 110 to go to the target application.

One or more workflow templates are built in a backend through the component running platform, and 90% of the automation building work is completed. Then, the workflow template is opened to the user for final customization operations, that is, selecting to update the work item and the information push object within the target application. In this way, the user can generate an automated workflow concisely and quickly, so that the user can monitor and/or update the progress of the work item in the target application in real time.

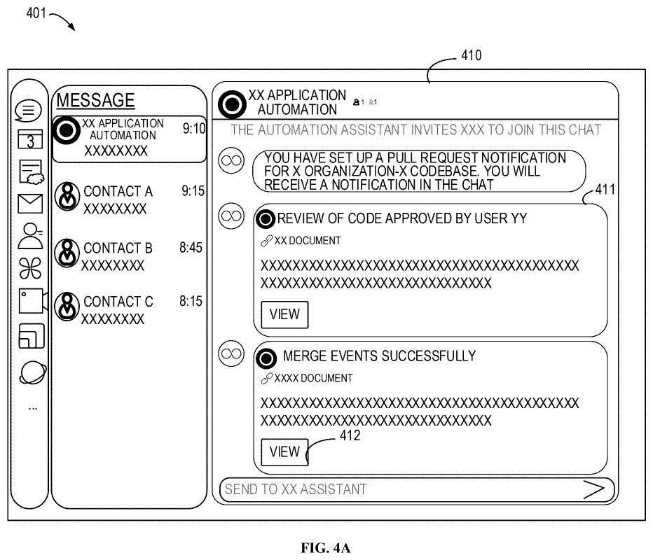

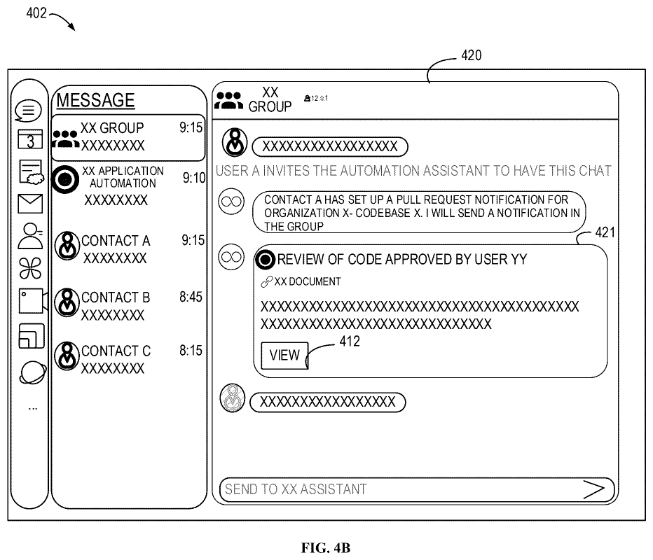

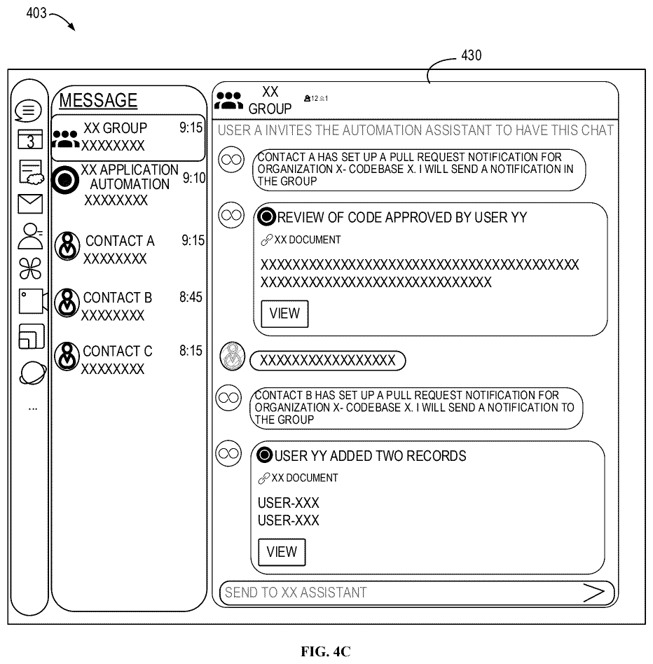

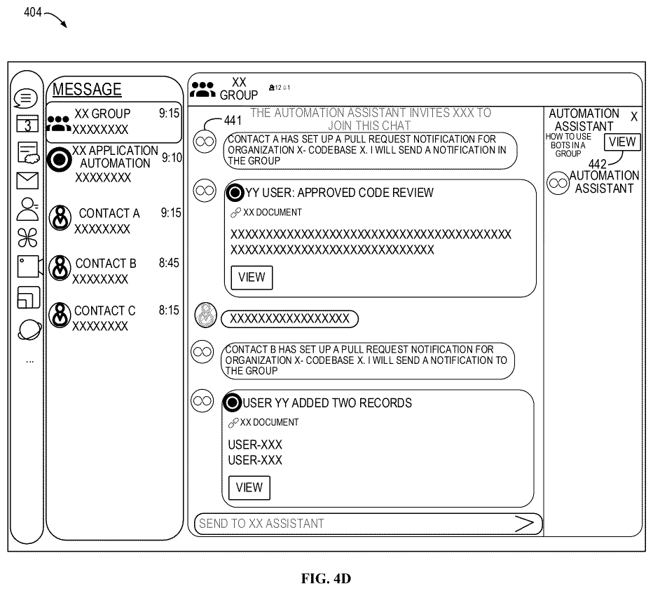

The following describes, with reference to FIGS. 4A-4D, that for monitoring and/or updating the progress of the work item in the target application in real time, the component running platform presents a message reminder in a chat window to enable the digital assistant to interact with the user. FIGS. 4A-4D are schematic diagrams of example interfaces 401-404 for presenting a message reminder in a chat window according to some embodiments of the present disclosure. For the purpose of discussion, the following will be described with reference to FIG. 1.

In the case that the information push object includes an individual user, the component running platform 110 creates a chat including the individual user and the digital assistant for the target application in response to the creation of the target workflow. After the target workflow is created, the component running platform 110 further creates a chat for the target data flow, where the individual user and the digital assistant for the target application are members of the chat, so that the digital assistant sends a notification associated with the work item to the user through the chat. In some embodiments, if information push objects of other workflows for the same target application are also the individual user himself/herself, the created chat may also be used to send a notification associated with a work item of another workflow. That is, in such an embodiment, the created chat may be shared by different workflows within one application.

As shown in an example interface 401 in FIG. 4A, after the target workflow is created, the component running platform 110 further automatically creates a chat including the individual user and the digital assistant for the target application (sometimes also referred to as “automation assistant”) based on the digital assistant, which, for example, corresponds to a chat window 410. The component running platform 110 also displays system prompt information in the chat window 410. For example, if the user A sets up a corresponding workflow for “X organization-X codebase”, the component running platform 110 will display system prompt information “The digital assistant invites the user A to have this chat” to indicate that the component running platform 110 has created a chat including the user A and the digital assistant.

In the case that the information push object includes multiple users belonging to a same chat, the component running platform 110 adds the digital assistant for the target application as a member of the chat in response to the creation of the target workflow. After the target workflow is created, the component running platform 110 adds the digital assistant as a member of the same chat including the multiple users.

As shown in an example interface 402 in FIG. 4B, after the target workflow is created, the component running platform 110 adds the digital assistant as a member of the same chat including multiple users. For example, a window corresponding to the same chat including multiple users is a chat window 420 for the digital assistant to interact with the multiple users.

In some embodiments, the component running platform 110 presents indication information about the action in the chat including the information push object in response to the detection of the action associated with the work item. In some examples, the component running platform 110 may detect the action associated with the work item through an interface with the target application. Then the component running platform 110 presents indication information about the action in the chat including the information push object.

As shown in the example interface 401 in FIG. 4A, the component running platform 110 presents indication information 411 about the action in a chat window 410 corresponding to a chat including the information push object based on the detection of the action associated with the work item. As shown in the example interface 402 in FIG. 4B, the component running platform 110 presents indication information 421 about the action in a chat window 420 corresponding to a chat including the information push object based on the detection of the action associated with the work item.

In some embodiments, the indication information is pushed by the digital assistant for the target application to the chat. After detecting the action associated with the work item, the component running platform 110 presents, in the chat including the information push object, the prompt information pushed by the digital assistant.

In some embodiments, the component running platform 110 presents the page within the target application associated with the action in response to receiving a trigger for at least a portion of the indication information. If the user clicks at least a portion of the indication information, the component running platform 110 will present the page within the target application associated with the action.

As shown in the example interface 401 or 402 in FIG. 4A or 4B, the user clicks at least a portion of the prompt information 410 or 420, and the component running platform 110 will present the page within the target application associated with the action. In some examples, if the user clicks a “View” control 412 presented on the prompt information 410 or 420, the component running platform 110 will present the page within the target application associated with the action.

As shown in FIG. 4A, if the user A sets up a corresponding workflow for “X organization-X codebase”, the component running platform 110 will present, in the chat window 410 of the user A and the digital assistant, prompt information pushed by the digital assistant “You have set up a pull request notification for X organization-X codebase”.

As shown in FIG. 4C, if the user A sets up a corresponding workflow for “X organization-X codebase”, the component running platform 110 will pull the digital assistant into a group chat including the user A. Correspondingly, in the group chat window 430, prompt information pushed by the digital assistant “The user A sets up a pull request notification for X organization-X codebase” is presented. Immediately afterwards, if the user B sets up a corresponding workflow for “XX team-XX codebase”, the component running platform 110 will continue to pull the digital assistant into a group chat including the user B. Correspondingly, in the group chat window 430, prompt information pushed by the digital assistant “The user B sets up a pull request notification for XX team-XX codebase” is presented.

As shown in the example interface 404 in FIG. 4D, the component running platform 110 presents a window including a “View” control 442 based on the user clicking an “Avatar” control 441 corresponding to the digital assistant. The user may click the “View” control 442 to view how to use the digital assistant in the group.

In this way, it is possible to monitor trends in real time based on the component running platform, so that users can work in an immersive way, thereby improving work efficiency.

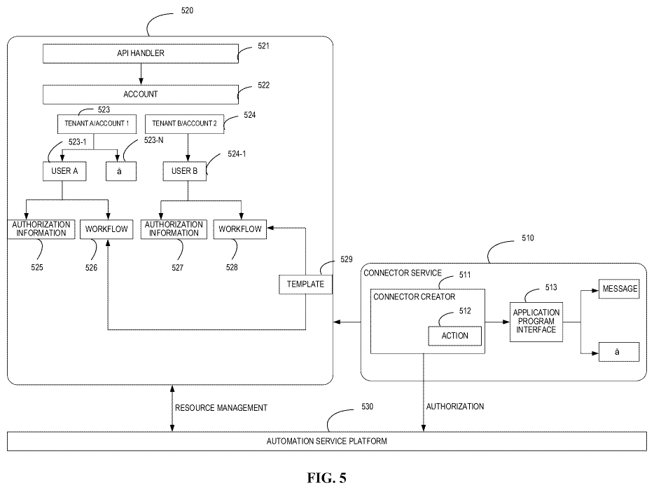

For ease of understanding, an example architecture of the background system of the present disclosure for supporting workflow automation will be described below with reference to FIG. 5. That is, through the management of authorization status, application connectors, and templates/workflows, the capabilities of the automation service platform 530 are implemented as part of the component running platform 110. The automation service platform 530 may provide the workflow automation service described above, for example, it may parse the target application to create the workflow template. FIG. 5 is a schematic diagram of an example architecture 500 of a background system for supporting workflow automation according to some embodiments of the present disclosure. For the purpose of discussion, the following will be described with reference to FIG. 1.

A connector service module 510 is deployed in the example architecture 500, and the connector service module 510 provides a connection with an external application. In some examples, if an action 512 of a connector creator 511 (also referred to as a “user”) is detected, authorization will be performed between the component running platform 110 and the platform 530. Referring back to the example interface 201 shown in FIG. 2A, if it is detected that the user clicks the corresponding control 211 of “Connect XX application”, authorization will be performed between the component running platform 110 and the platform 530, so that the capabilities of the platform 530 become part of the component running platform 110.

After the authorization is successful, authorization state management is performed. In some examples, the management of the authorization state includes providing the user with secure authorization links for multiple applications using encryption technologies. The management of the authorization state also includes maintaining and refreshing the user's authorization information to ensure that the user's authorization does not expire. The management of the authorization state also includes performing internal operations of the system of the component running platform 110 using the user authorization management state. For example, operations such as message notification and pulling a digital assistant within the component running platform 110.

In some examples, after the authorization is successful, linkage between the workflow and internal resources (for example, a digital assistant, a group, a message) of the component running platform 110 is achieved. Furthermore, events sent by the workflow can be monitored through an application program interface (API) 513 as a trigger (trigger). Thus, corresponding responses are performed within the component running platform 110 in the form of a remote procedure call (rpc) or an open platform API.

An application program interface (API) handler 512 and all accounts 522 under the handler 512 are also deployed in the example architecture 500. The API handler 512 is used to provide a management interface. For the accounts 522, a three-level tree structure for user identity management is established in the background.

It should be understood that the accounts 522 may be divided into different tenants, such as a tenant A 523 and a tenant B 524. Each tenant is a root node of a tree, and all users within each tenant are second-level nodes. For example, the tenant A 523 is a root node, and users A 523-1, . . . , users 523-N included in the tenant A 523 are second-level nodes. For another example, the tenant B 524 is a root node, and a user B 524-1 included in the tenant B 524 is a second-level node.

Resources (for example, authorization information, workflow) possessed by different users are third-level nodes of the tree. For example, resources (for example, authorization information 525, workflow 526) possessed by the user A are third-level nodes of a tree corresponding to the tenant A 523. For another example, resources (for example, authorization information 527, workflow 528) possessed by the user B are third-level nodes of a tree corresponding to the tenant B 524. Through the management of the three-level tree structure, a secure and reliable mapping between an identity corresponding to the component running platform 110 and the platform 530 and resource isolation between users and tenants are achieved.

The management module 520 for users and automated workflows further includes templates 529. The templates 529 inside the platform 530 are divided into two types: a personal workflow and a workflow template. In some examples, the workflow template is located in a separate space and shared by all users. Correspondingly, an application connector and authorization, as a jigsaw, are inserted into the workflow template to form an effective personal workflow.

In some examples, a user may create a personal workflow of the user based on the workflow template, and the personal workflow is only visible to the user. The user may also add, delete, search, and modify the user's own workflow to independently control the lifecycle of the workflow.

In this way, through the management of authorization status, application connectors, and templates/workflows, the capabilities of the automation service platform are implemented as part of the component running platform 110. Further, through the establishment of a three-level tree structure for user identity management, the security and isolation of user resources of the component running platform 110 are ensured. Correspondingly, by making the workflow communicate with the component running platform 110, it is possible to link the workflow with group messages, digital assistants (sometimes also referred to as “robots”), forms, and the like.

In summary, by communicating with the target application through the component running platform, the capabilities of the component running platform and the suite included therein are enriched. Correspondingly, it is possible to monitor trends in real time based on the component running platform, so that users can work in an immersive way, thereby improving work efficiency.

### Example Process

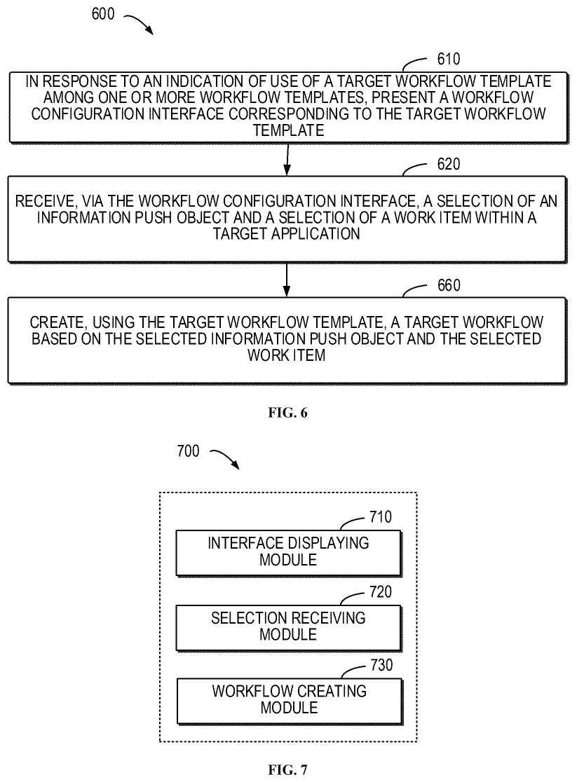

FIG. 6 is a flowchart of a process 600 for workflow automation according to some embodiments of the present disclosure. The process 600 may be implemented at the component running platform 110 and/or a digital assistant on the component running platform 110. For example, the method 600 may be implemented by an application, a component, or a suite running at the component running platform 110, or by such an application, component, or suite in conjunction with its server side. The process 600 will be described below with reference to FIG. 1 by taking the component running platform 110 as an example.

At block 610, the component running platform 110 presents a workflow configuration interface corresponding to a target workflow template among one or more workflow templates in response to an indication of use of the target workflow template. In some embodiments, the one or more workflow templates are used for a target application. In some embodiments, the workflow template may be generic or shared by multiple applications when created. In this case, the user may select a workflow template to be used for the target application.

At block 620, the component running platform 110 receives, through the workflow configuration interface, a selection of an information push object and a selection of a work item within the target application.

At block 630, the component running platform 110 creates, using the target workflow template, a target workflow based on the selected information push object and the selected work item, the target workflow being used to send a notification associated with the work item to the information push object.

In some embodiments, the information push object includes an individual user, and the process 600 further includes: in response to the creation of the target workflow, creating, for the target workflow, a chat whose members include the individual user and a digital assistant for the target application, so that the digital assistant sends a notification associated with the work item to the individual user through the chat.

In some embodiments, the process 600 further includes: in response to a detection of an action associated with the work item, presenting, in a chat including the information push object, indication information about the action.

In some embodiments, the indication information is pushed by a digital assistant for the target application to the chat, and the digital assistant is added to the chat in response to the creation of the target workflow.

In some embodiments, the process 600 further includes: in response to a reception of a trigger for at least a portion of the indication information, presenting a page within the target application associated with the action.

In some embodiments, receiving the selection of the work item within the target application includes: receiving, through a first selection entry, a selection of a tenant among one or more authorized tenants in the target application; and receiving, through a second selection entry, a selection of a work item among one or more work items under the selected tenant.

In some embodiments, the process 600 further includes: receiving, via an interface associated with the target application, a user indication to initiate workflow automation for the target application, before the receiving the indication of use; obtaining, in response to the user indication, authorization information associated with an automation service; and enabling, in response to the obtaining the authorization information, a use control for the one or more workflow templates.

In some embodiments, the user authorization associated with the automation service includes: first authorization information of an information push service to the automation service, and second authorization information of the target application to the automation service.

In some embodiments, each of the one or more workflow templates includes at least one of: one or more configurable parameters for the information push object, or one or more configurable parameters for the work item in an application.

In some embodiments, the workflow nodes in the one or more workflow templates are pre-configured.

In some embodiments, the one or more workflow templates are used for different types of work items.

### Example Apparatus and Device

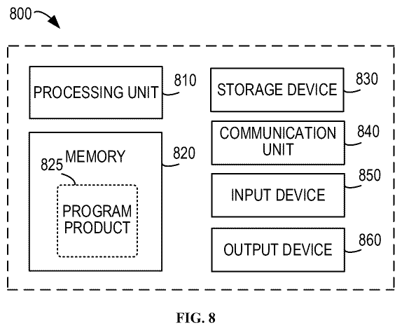

FIG. 7 is a schematic block diagram of a structure of an apparatus 700 for workflow automation according to some embodiments of the present disclosure. The apparatus 700 may be implemented as or included in the component running platform 110. Various modules/components in the apparatus 700 may be implemented in hardware, software, firmware, or any combination thereof.

As shown in the figure, the apparatus 700 includes an interface displaying module 710 configured to present a workflow configuration interface corresponding to a target workflow template among one or more workflow templates in response to an indication of use of the target workflow template; a selection receiving module 720 configured to receive, via the workflow configuration interface, a selection of an information push object and a selection of a work item within a target application; and a workflow creating module 730 configured to create, using the target workflow template and based on the selected information push object and the selected work item, a target workflow for sending a notification associated with the work item to the information push object.

In some embodiments, the information push object includes an individual user, and the apparatus 700 further includes a chat creation module configured to, in response to the creation of the target workflow, create a chat for the target workflow, where the individual user and a digital assistant for the target application being members of the chat, so that the digital assistant sends a notification associated with the work item to the individual user through the chat.

In some embodiments, the information push object includes multiple users belonging to the same chat, and the apparatus 700 further includes a member adding module configured to, in response to the creation of the target workflow, add the digital assistant for the target application as a member of the chat, and the digital assistant is added to the chat in response to the creation of the target workflow.

In some embodiments, the apparatus 700 further includes an information presentation module configured to, in response to a detection of an action associated with the work item, present, in a chat including the information push object, indication information about the action.

In some embodiments, the indication information is pushed by the digital assistant for the target application to the chat.

In some embodiments, the interface displaying module 710 is further configured to, in response to receiving a trigger for at least a portion of the indication information, present a page within the target application associated with the action.

In some embodiments, the selection receiving module 720 is further configured to: receive, through the first selection entry, a selection of a tenant among one or more authorized tenants in the target application; and receive, through the second selection entry, a selection of a work item among one or more work items under the selected tenant.

In some embodiments, the apparatus 700 further includes a control enabling module configured to: receive, via an interface associated with the target application, a user indication to initiate workflow automation for the target application, before receiving the indication of use; obtain, in response to the user indication, authorization information associated with an automation service; and enable, in response to obtaining the authorization information, a use control for the one or more workflow templates.

In some embodiments, the control enabling module is further configured to first authorization information of an information push service to the automation service, and second authorization information of the target application to the automation service.

In some embodiments, each of the one or more workflow templates includes at least one of: one or more configurable parameters for the information push object, or one or more configurable parameters for the work item in an application.

In some embodiments, the workflow nodes in the one or more workflow templates are pre-configured.

In some embodiments, the one or more workflow templates are used for different types of work items.

FIG. 8 is a block diagram of an electronic device 800 capable of implementing one or more embodiments of the present disclosure. It should be understood that the electronic device 800 shown in FIG. 8 is only example and should not constitute any limitation to the functions and scope of the embodiments described herein. The electronic device 800 shown in FIG. 8 may be used to implement the component running platform 110 in FIG. 1 or the apparatus 700 shown in FIG. 7.

As shown in FIG. 8, the electronic device 800 is in the form of a general electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and can execute various processes according to a program stored in the memory 820. In a multiprocessor system, multiple processing units execute computer-executable instructions in parallel to improve the parallel processing capability of the electronic device 800.

The electronic device 800 typically includes multiple computer storage media. Such media may be any accessible medium available to the electronic device 800, including but not limited to volatile and non-volatile media, removable and non-removable media. The memory 820 may be volatile memory (e.g., register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium, and may include machine-readable media, such as a flash drive, a disk, or any other medium, which may be capable of storing information and/or data and may be accessed within the electronic device 800.

The electronic device 800 may further include additional removable/non-removable, volatile/non-volatile storage media. Although not shown in FIG. 8, a disk drive for reading from or writing to a removable, non-volatile disk (e.g., “floppy disk”), and an optical disk drive for reading from or writing to a removable, non-volatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 enables communication with other electronic devices through a communication medium. Additionally, the functions of the components of the electronic device 800 may be implemented in a single computing cluster or a plurality of computing machines that can communicate through a communication connection. Thus, the electronic device 800 may operate in a networked environment using a logical connection with one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown), such as storage devices, display devices, etc., with one or more devices that enable the user to interact with the electronic device 800, or with any device (e.g., a network card, a modem, etc.) that enables the electronic device 800 to communicate with one or more other electronic devices, through the communication unit 840 as required. Such communication may be performed via an input/output (I/O) interface (not shown).

According to an example implementation of the present disclosure, a computer-readable storage medium is provided, having computer-executable instructions stored thereon, where the computer-executable instructions are executed by a processor to implement the methods described above. According to an example implementation of the present disclosure, a computer program product is further provided, which is tangibly stored on a non-transitory computer-readable medium and includes computer-executable instructions, and the computer-executable instructions are executed by a processor to implement the methods described above.

Various aspects of the present disclosure are described herein with reference to the flowcharts and/or block diagrams of the methods, apparatus, devices, and computer program products implemented according to the present disclosure. It should be understood that each block of the flowcharts and/or block diagrams and the combination of blocks in the flowcharts and/or block diagrams may be computer-readable program instructions.

These computer-readable program instructions may be provided to a processing unit of a general-purpose computer, a special-purpose computer, or other programmable data processing apparatus, to produce a machine, so that the instructions, when executed by the processing unit of the computer or other programmable data processing apparatus, produce an apparatus for implementing the functions/actions specified in one or more blocks in the flowcharts and/or block diagrams. These computer-readable program instructions may also be stored in a computer-readable storage medium, and these instructions cause the computer, programmable data processing apparatus, and/or other devices to work in a specific way, so that the computer-readable medium storing the instructions includes a product, which includes instructions for implementing various aspects of the functions/actions specified in one or more blocks in the flowcharts and/or block diagrams.

The computer-readable program instructions may be loaded onto a computer, other programmable data processing apparatus, or other device, so that a series of operation steps are executed on the computer, other programmable data processing apparatus, or other device to produce a computer-implemented process, so that the instructions executed on the computer, other programmable data processing apparatus, or other device implement the functions/actions specified in one or more blocks in the flowcharts and/or block diagrams.

The flowcharts and block diagrams in the drawings show possible architectures, functions, and operations of systems, methods, and computer program products implemented according to multiple implementations of the present disclosure. In this regard, each block in the flowchart or block diagram may represent a module, a program segment, or a part of an instruction, and the module, the program segment, or the part of the instruction contains one or more executable instructions for implementing a specified logical function. In some alternative implementations, the functions marked in the blocks may also occur in a different order than the order marked in the drawings. For example, two consecutive blocks may actually be executed substantially in parallel, or sometimes may be executed in the reverse order, depending on the functions involved. It should also be noted that each block in the block diagram and/or flowchart, and the combination of the blocks in the block diagram and/or flowchart, may be implemented by a dedicated hardware-based system that performs specified functions or actions, or may be implemented by a combination of dedicated hardware and computer instructions.

Various implementations of the present disclosure have been described above, and the above description is exemplary, non-exhaustive, and not limited to the disclosed implementations. Many modifications and changes will be obvious to ordinary skill in the art without departing from the scope and spirit of the described implementations. The selection of terms used in this document is intended to best explain the principles, practical applications, or improvements to the technology in the market of the implementations, or to enable other ordinary skill in the art to understand the various implementations disclosed in this document.

1. A method for workflow automation, comprising:
in response to an indication of use of a target workflow template among one or more workflow templates, presenting a workflow configuration interface corresponding to the target workflow template;
receiving, via the workflow configuration interface, a selection of an information push object and a selection of a work item within a target application; and
creating, using the target workflow template and based on the selected information push object and the selected work item, a target workflow for sending a notification associated with the work item to the information push object.

2. The method according to claim 1, wherein the information push object comprises an individual user, and the method further comprises:
in response to the creation of the target workflow, creating for the target workflow a chat whose members comprising the individual user and a digital assistant for the target application, so that the digital assistant sends a notification associated with the work item to the individual user through the chat.

3. The method according to claim 1, further comprising:
in response to a detection of an action associated with the work item, presenting, in a chat comprising the information push object, indication information about the action.

4. The method according to claim 3, wherein the indication information is pushed by a digital assistant for the target application to the chat, and the digital assistant is added to the chat in response to the creation of the target workflow.

5. The method according to claim 3, further comprising:
in response to a reception of a trigger for at least a portion of the indication information, presenting a page within the target application associated with the action.

6. The method according to claim 1, wherein receiving the selection of the work item within the target application comprises:
receiving, through a first selection entry, a selection of a tenant among one or more authorized tenants in the target application; and
receiving, through a second selection entry, a selection of a work item among one or more work items under the selected tenant.

7. The method according to claim 1, further comprising:
receiving, via an interface associated with the target application, a user indication to initiate workflow automation for the target application, before the indication of use is received;
in response to the user indication, obtaining authorization information associated with an automation service; and
in response to the obtaining the authorization information, enabling a use control for the one or more workflow templates.

8. The method according to claim 7, wherein user authorization associated with the automation service comprises:
first authorization information of an information push service to the automation service, and
second authorization information of the target application to the automation service.

9. The method according to claim 1, wherein each of the one or more workflow templates comprises at least one of:
one or more configurable parameters for the information push object, or
one or more configurable parameters for the work item in an application.

10. The method according to claim 1, wherein workflow nodes in the one or more workflow templates are pre-configured.

11. The method according to claim 1, wherein the one or more workflow templates are used for different types of work items.

12. An electronic device, comprising:
at least one processing unit; and
at least one memory coupled to the at least one processing unit and storing instructions executable by the at least one processing unit, the instructions, when executed by the at least one processing unit, causing the electronic device to perform acts comprising:
in response to an indication of use of a target workflow template among one or more workflow templates, presenting a workflow configuration interface corresponding to the target workflow template;
receiving, via the workflow configuration interface, a selection of an information push object and a selection of a work item within a target application; and
creating, using the target workflow template and based on the selected information push object and the selected work item, a target workflow for sending a notification associated with the work item to the information push object.

13. The device according to claim 12, wherein the information push object comprises an individual user, and the acts further comprise:
in response to the creation of the target workflow, creating for the target workflow a chat whose members comprising the individual user and a digital assistant for the target application, so that the digital assistant sends a notification associated with the work item to the individual user through the chat.

14. The device according to claim 12, wherein the act further comprise:
in response to a detection of an action associated with the work item, presenting, in a chat comprising the information push object, indication information about the action.

15. The device according to claim 14, wherein the indication information is pushed by a digital assistant for the target application to the chat, and the digital assistant is added to the chat in response to the creation of the target workflow.

16. The device according to claim 14, wherein the act further comprise:
in response to a reception of a trigger for at least a portion of the indication information, presenting a page within the target application associated with the action.

17. The device according to claim 12, wherein receiving the selection of the work item within the target application comprises:
receiving, through a first selection entry, a selection of a tenant among one or more authorized tenants in the target application; and
receiving, through a second selection entry, a selection of a work item among one or more work items under the selected tenant.

18. The device according to claim 12, wherein the act further comprise:
receiving, via an interface associated with the target application, a user indication to initiate workflow automation for the target application, before the indication of use is received;
in response to the user indication, obtaining authorization information associated with an automation service; and
in response to the obtaining the authorization information, enabling a use control for the one or more workflow templates.

19. The device according to claim 18, wherein user authorization associated with the automation service comprises:
first authorization information of an information push service to the automation service, and second authorization information of the target application to the automation service.

20. A non-transitory computer-readable storage medium having stored thereon a computer program executable by a processor to implement acts comprising:
in response to an indication of use of a target workflow template among one or more workflow templates, presenting a workflow configuration interface corresponding to the target workflow template;
receiving, via the workflow configuration interface, a selection of an information push object and a selection of a work item within a target application; and
creating, using the target workflow template and based on the selected information push object and the selected work item, a target workflow for sending a notification associated with the work item to the information push object.
